(19) United States
(12) Patent Application Publication
(10) Pub. No.: US 2010/0200520 A1
(43) Pub. Date: Aug. 12, 2010

(54) Method and a Device for the Dewatering of a Fibre Suspension in a Vertical Elongate Container Formed of Two Endless Wire Bands

(75) Inventor: Ebbe Hoden, Strangnas (SE)

Correspondence Address: STIENNON & STIENNON, 612 W. MAIN ST., SUITE 201, P.O. BOX 1667, MADISON, WI, 53701-1667, US

(73) Assignee: METSO PAPER, INC., Helsinki (FI)

(21) Appl. No.: 12/678,458

(22) PCT Filed: Sep. 12, 2008
(86) PCT No.: PCT/SE2008/000509

§ 371 Date: Apr. 27, 2010

(30) Foreign Application Priority Data
Sep. 17, 2007 (SE) 0702092-8

(51) Int. Cl. B01D 33/052; B01D 33/048; B01D 33/056

(52) U.S. Cl. 210/770; 210/350

(57) ABSTRACT

A fiber suspension is dewatered by being introduced from above into a container formed of a wider endless flexible wire band and a more slender endless flexible wire band, which mutually are lap joined at adjacent border parts, which carry a respective part of a coupling, the wider band being reshaped to a C-shape, by folding its border parts over one of the main surfaces, and bringing them into overlapping contact with the overlapping border parts of the extended more slender band. The screening pipe is established along a common longitudinal section of the tracks of the two wire bands, the lower end part of the screening container being kept substantially sealed, and the fiber suspension being introduced by elevated pressure to a centrally placed nozzle assembly with spray nozzles spaced-apart around the nozzle assembly, toward the screening pipe's inside.

### CROSS REFERENCES TO RELATED APPLICATIONS

This application is a U.S. national stage application of International App. No. PCT/SE2008/000509, filed Sep. 12, 2008, the disclosure of which is incorporated by reference herein, and claims priority on Swedish Application No. 0702092-8, filed Sep. 17, 2007, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a method and a device for dewatering of a fiber suspension, comprising a vertically elongate and vertically oriented tubular container of a liquid-permeable fiber-separating material such as wire cloth and a device for introducing the fiber suspension into the upper part of the container.

The fiber suspension may, for instance, be the liquid suspension removed from a stock, which contains a residual amount of fibers. It may be desirable to, from the suspension, separate at least a part of the particles in order to be able to use the same in a useful way. Furthermore, it is necessary or favorable to, from the suspension to remove as great a part of the particles as possible before the suspension is brought back to the environment.

It is in that connection previously well known that it is possible to lead the suspension through a screening material through which the liquid share of the suspension passes, the fiber fraction largely being collected on the screening material and then being collected for further handling.

A problem is in the connection to carry out such a separation in an efficient way. Therefore, an object of the invention is to provide a technique, by which separation of fibers from a fiber suspension can be carried out in a simple and efficient manner.

The object is attained by the invention.

### SUMMARY OF THE INVENTION

The invention comprises essentially that the screening material is formed to a vertically oriented elongate container, that the suspension is introduced into the screening container via a vertical elongate nozzle assembly, which in all essentials is concentrically arranged in the container, and that the nozzle assembly is arranged to spray the suspension via a plurality of nozzles spaced-apart around the assembly, against the inside of the shell wall of the container.

The screening container is formed of two endless wire bands, one wider and one more slender, which mutually are lap joined at adjacent border parts, which along the length thereof carry a respective part of a Velcro® coupling, the bands together being formed as a pipe, the wider band being formed to C-shape by folding the two border parts thereof in over one of the main surfaces of the band, the folded border parts of the wider band being brought into overlapping contact with the border parts of the extended more slender wire band, which along the length thereof carry the second part of the Velcro coupling, and that the tubular screening container is established along a common longitudinal section of the paths of the two running wire bands, that the lower end part of the screening container is kept substantially sealed, and that a fiber suspension is introduced by elevated pressure into a nozzle assembly, which is centrally placed in the screening container running downward and open upward, the fiber suspension being led out in the form of jets of high speed from the nozzle assembly via a number of spray nozzles spaced-apart around the nozzle assembly, and is sprayed against the inside of the screening container, so that a great share of liquid directly is led through the wire cloth and the fibers to a great share are retained on the inside of the container and are conveyed by the wire cloth. The suspension flow is adapted so that the container in all essentials is not flowed by suspension, i.e., so that the jets from the nozzle assembly 1 freely pass between the same and the inside of the container.

### BRIEF DESCRIPTION OF THE DRAWINGS

FIG. 1 is a schematic side view of a device according to the invention.

FIG. 2 is a section view of the device of FIG. 1 taken along section line

FIG. 3 is a schematic section view of the device of FIG. 1 taken along line

FIG. 4 is a schematic section view of the device of FIG. 1. taken along line IV-IV in FIG. 1.

FIG. 5 shows a developed embodiment of the device, in a section through the screening container formed of the wire bands.

FIG. 6 is a schematic section view of the device of FIG. 5 taken along the line VI-VI.

### DESCRIPTION OF THE PREFERRED EMBODIMENTS

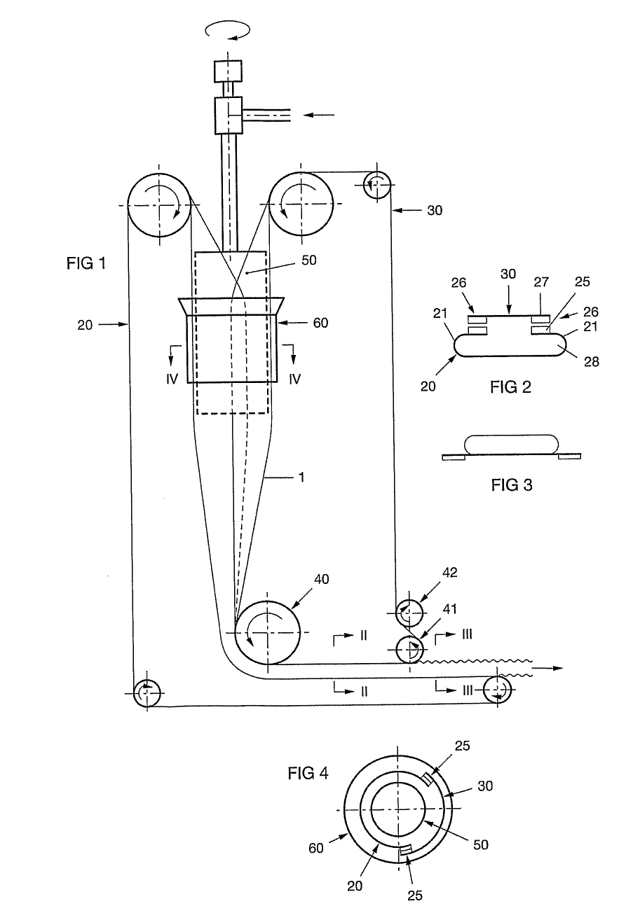

FIG. 1 shows a wider endless circumferential wire band 20 and a more slender endless wire band 30, which along a vertical distance run to each other and are formed to a vertically oriented and running pipe 1, which from above receives a fiber suspension. The lower end of the screen pipe extends around a deflection roller 40 and is in that connection substantially closed. In FIG. 2, it can be seen that the wider band 20 is folded to a C-shape and has the edges 21 thereof turned in over one of the main surfaces of the band 20. On the outside of the edges 21, there is, along the respective edge, a first part 25 of a Velcro coupling 26. The second part of the Velcro coupling 27 lies along one of the edges of one of the main surfaces of the more slender band 30. The suspension that is introduced into the tubular container 1, is dewatered through the wall of the container, and a fiber fraction 28 is conveyed in the pipe running past the deflection wheel 40. After that, the more slender band 30 extends around 180° of a first deflection roller 41 and then around a part of a second deflection roller 42 to be lifted off from the wider band 20, which runs further, the edge parts 21 thereof being dropped back out in the plane of the band 20, i.e., the memory state of the band 20, before the band runs back at deflection rollers to afresh form the upward open tubular screening container 1. After the deflection/lifting-off rollers 41, 42, the more slender wire band 30 is brought back via deflection rollers to afresh form the running screening pipe 1.

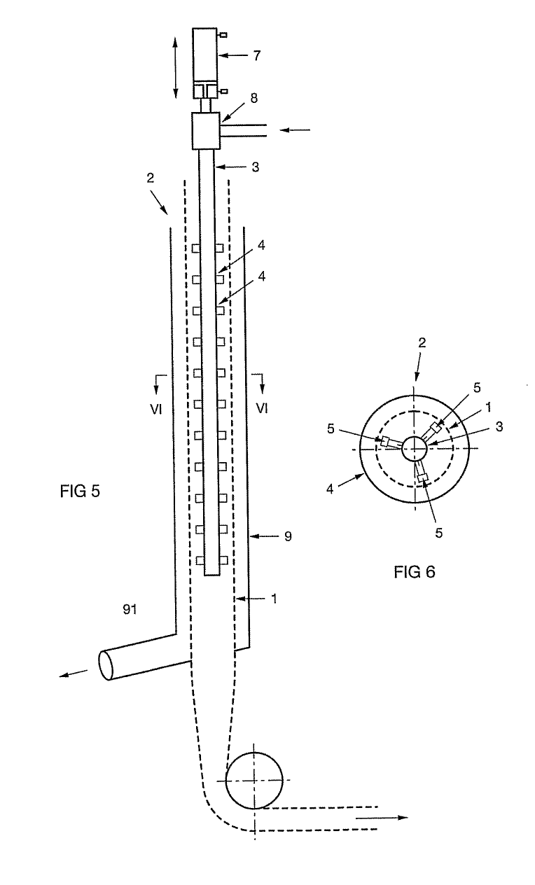

In FIGS. 1 and 4, it can be seen that a vertically oriented support pipe 50 forms a support core around the circumference of which the bands 20, 30 are laid by an outer tubular control device 60, which is shown to be in the shape of a funnel, so that the border areas of the bands 20, 30 are brought to overlapping and mutual detachable engagement via the Velcro coupling parts 25, 27 thereof (cf. FIG. 2). The deflection rollers 41, 42 form a device in order to limit the length of the tubular screening container. In FIG. 5, it is shown that the pipe 1 is surrounded by a housing 9 having a bottom outlet 91, for liquid passing through the wall of the screen pipe 1. From above, a nozzle assembly then extends down into the container 1. The nozzle assembly 2 is shown to have a pipe 3 generally directed vertically downward, which connects to a plurality of groups 4 of nozzles 5, which are arranged to spray the suspension which is introduced via the pipe 3, radially outward against the inside of the container 1. In FIG. 6, it can be seen that the nozzles of the respective group 4 are distributed around the circumference of the assembly 2. The assembly 2 is in all essentials concentric with the pipe 1 and is arranged rotatable around the axis thereof and of the container by means of a schematically shown driving engine 7. The suspension is supplied to the pipe 3 by elevated pressure, for instance via a swivel connection 8. The container 1 is surrounded by a housing 9, the walls of which are lying at radial distance outside the container 1 and has a bottom outlet 91. The pipe 1 extends through the bottom of the housing 9.

An engine 7 is shown arranged to impart the assembly 2 a rotary motion around the axis of the pipe. The nozzles 5 are preferably arranged to emit conically diverging sprays to as far as possible distribute the suspension over the inner area of the free wall surface of the pipe 1.

It will be appreciated that the pipe 1 downstream of the forming pipes 50, 60 is not screened off by some supporting structure, so that the bands 20, 30 far-reaching can be utilized for the screening.

By the fact that the assembly 2 is rotated around the axis of the container 1, the suspension that by elevated pressure is directed toward the inside of the container 1 will be more evenly distributed over the bands 20, 30. The assembly 2 is substantially stationary, while the screening pipe 1 runs downward in relation to the assembly 2.

From FIG. 1, it can be realized that the fiber fraction 28 can be led further from the extended wider band 20 downstream the door opening device 41, 42 on a conveyor (not shown). Furthermore, it is realized that it is possible to mechanically by pressing additionally dewater the fiber cake 28, when the border parts 21 of the wire band 20 have been turned away from the fiber residual path.

By utilizing Velcro couplings to detachably connect the wire bands 20, 30 for the formation of the tubular screening container 1, an efficient screening is attained of the fiber suspension, especially by the fact that the suspension sprays are not blocked by support structures. The liquid share of the suspension can thereby efficiently pass through the wire bands 20, 30.

The flow of suspension introduced via the spray assembly can be controlled so that the pipe 1 is liquid-filled only in a lower portion, upstream of the shut-off/deflection device 40, so that the sprays from the assembly 2 are not stopped by accumulated liquid in the pipe 1. By driving the sprays using an elevated pressure o against the inside of the pipe 1, an efficient separation is attained, and the sprays also afford a cleaning effect, so far that they tend to put down fibers that tend to remain on the inside of the wall of the container 1 running downward.

The driving engine 7 can impart the nozzle assembly the rotary motion described above and in addition possibly a reciprocating motion in the vertical direction.

1-10. (canceled)

11. A method for the dewatering of a fiber suspension comprising the steps of
forming an elongate vertically oriented tubular container of a fiber separation material formed of a first endless flexible wire band, and a second endless flexible wire band, wherein the first flexible wire band is wider than the second flexible wire band;
wherein the first flexible wire band is caused to travel about a first track;
wherein the first flexible wire band has a main surface and two border parts adjacent to the main surface, and a first coupling part is arranged at each adjacent border part of the first flexible wire band;
wherein the second flexible wire band is caused to travel about a second track;
wherein the second flexible wire band has second coupling parts arranged at borders formed by the second flexible wire band;
further comprising the steps of:
reshaping a portion of the first flexible wire band in to a C-shape by folding the two border parts over the main surface of the first flexible wire band;
forming the tubular container by bringing into overlapping contact the first coupling parts of the first wire band with the second coupling parts of the second flexible wire band so that the first flexible wire band and the second flexible wire band are mutually joined by said first coupling parts and said second coupling parts, and define an inside of the tubular container;
wherein the tubular container is established along a common longitudinal section of the first track and the second track of the first wire band and the second wire band respectively;
wherein the tubular container has a lower end part of the tubular container which is kept substantially sealed;
introducing a fiber suspension at an elevated pressure into the tubular container from above and through a nozzle assembly, placed centrally in the tubular container; and
leading the fiber suspension out from the nozzle assembly, toward the inside of the container via a number of nozzles spaced-apart around the nozzle assembly.

12. The method of claim 11 further comprising the step of rotating the nozzle assembly in relation to the tubular container and around a substantially vertical longitudinal axis defined by the tubular container.

13. The method of claim 11 wherein a pipe forming part of the nozzle assembly is directed vertically downward and carries a plurality of groups of nozzles spaced-apart along the pipe, the nozzles of each group being spaced-apart circumferentially around the pipe.

14. The method of claim 13, wherein the nozzles form suspension jets that are directed radially toward the inside of the container.

15. The method of claim 11 wherein the first flexible wire band and the second flexible wire band are formed of wire cloth.

16. The method of claim 11 further comprising the step of:
imparting a flat shape to the lower end part of the tubular container and directing the tubular container generally horizontal with the second wire band situated on top of the first wire band;
leading the second wire band around at least one deflection roller and separating the second wire band from the first wire band by separating the second coupling parts from the first coupling parts of the first flexible wire band; and
after separating the first wire band from the second wire band, folding the adjacent border parts of the first band to a plane defined by the main surface of the first wire band, so that an initially dewatered fiber fraction on the central part of the first wire band is exposed to a mechanical pressing dewatering on the first wire track.

17. A device for the dewatering of a fiber suspension, comprising
a vertically elongate and vertically oriented tubular container of a liquid-permeable fiber-separating material;
wherein the container is formed of a first and a second endless flexible wire bands, wherein the first flexible wire band is wider than the second flexible wire band;
wherein the first and second endless flexible wire bands are mounted to follow first and second tracks respectively, said tracks being arranged to run in parallel in the vicinity of each other in a common longitudinal section of the tracks;
means for curving the first band to a generally C-shaped cross section, and wherein the first band has two first edge parts, each first edge part carrying a first part of a coupling extending along and around the first band;
wherein the second band has two second edge parts, each second edge part carrying a second part of the coupling which extends along and around the second band;
means for bringing the first parts of the coupling into overlapping contact with the second parts of the coupling to form the vertically elongate and vertically oriented tubular container, and to define an inside circumference wall of the tubular container; and
a nozzle assembly, connected to a source of fiber suspension at an elevated pressure, and positioned centrally in the tubular container, the nozzle assembly having a plurality of nozzles which are arranged to direct jets of the fiber suspension against the inside of the circumference wall of the container.

18. The device of claim 17, wherein the plurality of nozzles of the nozzle assembly has a plurality of groups of nozzles spaced-apart along the nozzle assembly, the nozzles of the groups being spaced-apart around the circumference of the assembly.

19. The device of claim 17, further comprising a driving assembly to which the nozzle assembly is mounted for rotary motion around an axis defined by the vertically oriented tubular container.

20. The device of claim 19, wherein the nozzle assembly is mounted to the driving assembly for reciprocating motion along the axis of the container, and wherein the container is stationarily mounted and wherein the container is enclosed by a housing spaced from the tubular container, the housing arranged to collect suspension liquid which passes through the tubular container, wherein the housing has a bottom drainage for leading away collected suspension liquid.

21. The device of claim 17 wherein the first flexible wire band and the second flexible wire band are formed of wire cloth.

22. A device for the dewatering of a fiber suspension, comprising:
an elongate vertically oriented tubular container of a fiber separation material formed of a first endless flexible wire band, and a second endless flexible wire band, wherein the first flexible wire band is wider than the second flexible wire band;
wherein the first flexible wire band is mounted to travel about a first track;
wherein the first flexible wire band has a main surface and two border parts adjacent to the main surface, and a first coupling part arranged at each adjacent border part of the first flexible wire band;
wherein the second flexible wire band is mounted to travel about a second track;
wherein the second flexible wire band has second coupling parts arranged at border parts formed by the second flexible wire band;
wherein portions of the first track and portions of the second track are arranged in parallel in the vicinity of each other to form a common vertical section of the tracks;
a vertically oriented support pipe positioned with respect to the common vertical section of the tracks and forming a support core having a circumference around which the first flexible wire band, and the second flexible wire band are positioned by an outer tubular control device, so that the first coupling parts of the first flexible wire band and the second couplings parts of the second flexible wire band are brought into overlapping and mutually detachable engagement to form the elongate vertically oriented tubular container and to define an inside circumference wall of the tubular container;
a nozzle assembly, connected to a source of fiber suspension at an elevated pressure, and positioned centrally in the tubular container, the nozzle assembly having a plurality of nozzles which are arranged to direct jets of the fiber suspension against the inside of the circumference wall of the container; and
wherein the tubular container has a lower end part of the tubular container which is kept substantially sealed.

23. The device of claim 22 wherein the outer tubular control device has a funnel shape.

24. The device of claim 22 further comprising a driving assembly to which the nozzle assembly is mounted for rotary motion around an axis defined by the vertically orientated tubular container.

25. The device of claim 24 wherein the nozzle assembly is mounted to the driving assembly for reciprocating motion along the axis of the container, and wherein the container is stationarily mounted and the container is enclosed by a housing spaced from the tubular container, the housing arranged to collect suspension liquid which passes through the tubular container, wherein the housing has a bottom drainage for leading away collected suspension liquid.
